(19) United States
(12) Patent Application Publication
(10) Pub. No.: US 2005/0130082 A1
(43) Pub. Date: Jun. 16, 2005

(54) Developing solution for photoresist

(76) Inventors: Takashi Kanda, Niigata (JP); Masaki Kondo, Niigata (JP)

Correspondence Address: EDWARDS & ANGELL, LLP, P.O. BOX 55874, BOSTON, MA, 02205, US

(21) Appl. No.: 10/498,640

(22) PCT Filed: Dec. 13, 2002
(86) PCT No.: PCT/JP02/13102

(30) Foreign Application Priority Data
Dec. 14, 2001 (JP) 2001-382215

(51) Int. Cl. G03C 5/18

(52) U.S. Cl. 430/464

(57) ABSTRACT

A novel developing solution for photoresists which is suitable for use as a developing solution for a photoresist formed on an aluminum-containing base formed on a wafer. It comprises an alkali builder, a calcium compound, and a chelating agent, the chelating agent being selected from the group consisting of 1-hydroxyethylidene-1,1-diphosphonic acid, aminotrimethylenephosphonic acid, 2-phosphonobutane-1,2,4-tricarboxylic acid, ethylenediaminetetramethylenphosphonic acid, diethylencetriaminepentamethylenephosphonic acid, hexamethylenediaminetetraethylenephosphonic acid, and diethylenetriaminepenta(methylenephosphonic acid).

### FIELD IN INDUSTRY

The present invention is related to a developing solution for photoresist.

### PRIOR ART

In recent years, use of a photoresist having additionally an epoxy-containing substance in the traditional resist has been proposed in order to obtain higher performance in production of WL-CSP. For such a photoresist, it is necessary to use a more alkaline developer since its solubility in the traditional developing solution is low. However, if there is aluminum present in the undercoat of the photoresist or in the area of contact with developer, erosion of aluminum due to the strong alkalinity of the developing solution presents problems.

Thus, a developing solution without erosion of aluminum and with the capability of developing the photoresist having an epoxy-containing substance has been in demand.

### DISCLOSURE OF INVENTION

The inventors found that by adding a calcium-containing compound and a specific chelating agent to the developing solution the above problem can be solved, and thus achieved the present invention.

Thus, the present invention is related to a developing solution for photoresist. The developing solution contains an alkali builder, a calcium-containing compound and a chelating agent. The chelating agent is selected from the following group: 1-hydroxyethylidene-1,1-diphosphonate, aminotrimethylene phosphonate, 2-phosphonobutane-1,2,4-tricarbonate, ethylenediaminetetramethylene phosphonate, diethylenetriaminepentamethylene phosphonate, hexamethylenediaminetetramethylene phosphonate and diethylenetriaminepentamethylene phosphonate.

The calcium-containing compound can be halides, such as calcium chloride, calcium bromide, calcium iodide, etc., oxygen compounds, such as calcium carbonate, calcium hydroxide, etc., inorganic acids and their salts, such as calcium nitrate, calcium acetate, etc., and organic compounds. These compounds can be used individually or, if necessary, in combination of two or more compounds. Preferably, the calcium-containing compound is calcium chloride. The preferable concentration of calcium ion in the developer is in the range from 0.0005 mol/L to 0.1 mol/L, more preferably in the range from 0.001 mol/L to 0.01 mol/L.

The chelating agent is selected from the following group: 1-hydroxyethylidene-1,1-diphosphonate, aminotrimethylene phosphonate, 2-phosphonobutane-1,2,4-tricarbonate, ethylenediaminetetramethylene phosphonate, diethylenetriamine-pentamethylene phosphonate, hexamethylenediaminetetramethylene phosphonate and diethylenetriaminepentamethylene phosphonate, preferably 1-hydroxyethylidene-1,1-diphosphonate, aminotrimethylene phosphonate, 2-phosphonobutane-1,2,4-tricarbonate, and hexamethylenediaminetetramethylene, more preferably 1-hydroxyethylidene-1,1-diphosphonate. These chelating agents can be used individually or, if necessary, in combination of two or more compounds.

The concentration of the chelating agent is preferably in the range from 0.00005 mol/L to 1 mol/L, more preferably in the range from 0.0005 mol/L to 0.02 mol/L.

The molar ratio of calcium ion concentration to chelating agent concentration is preferably in the range from 1:0.1 to 1:10, more preferably in the range from 1:0.5 to 1:2.

For the alkali builder, any alkaline substance can be used, such as alkali metal hydroxides (e. g. sodium hydroxide, potassium hydroxide, and lithium hydroxide), alkali metal silicates (e. g., sodium orthosilicate, potassium orthosilicate, sodium metasilicate, and potassium metasilicate), alkali metal phosphates (e. g., tertiary sodium phosphate, and tertiary potassium phosphate), etc. These compounds can be used individually or, if necessary, in combination of two or more compounds. Preferably, the alkali builder is sodium hydroxide or potassium hydroxide, most preferably potassium hydroxide.

The present developing solution is alkaline, preferably with a pH of at least 12, more preferably at least 13.

The present developing solution preferably contains a chelating assistant. The chelating assistant is an appropriate weak chelating agent, preferably selected from the following group: citric acid, tartaric acid, glycolic acid, and sodium tripolyphosphate. By adding the chelating assistant, the storage stability of the present developer can be enhanced, and precipitation of calcium during storage can be prevented. These chelating assistants can be used individually or, if necessary, in combination of two or more compounds.

The amount of the chelating assistant is preferably in the range from 0.0005 mol/L to 0.1 mol/L, more preferably in the range from 0.001 mol/L to 0.01 mol/L.

The present developing solution can contain a surface-active agent. The surface-active agent is preferably a nonionic or anionic surface-active agent.

Examples of the nonionic surface-active agent are polyoxyethylene alkyl ethers, such as polyoxyethylene lauryl ether, polyoxyethylene stearyl ether, and polyoxyethylene octyl ether, sorbitan alkylates, such as sorbitan laurate, and alkylphenoxypolyalkoxyalkyl phosphate. Examples of the anionic surface-active agent are alkylbenzenesulfonate, polyoxyethylenealkylphenyl ether sulfate, alkylphenoxypolyalkoxyalcohol phosphate, polyoxyethylenealkyl ether sulfate, and their salts (alkali metal salts, ammonium salts, and amine salts, such as triethylamine, triethanolamine, and diisopropylamine). A most preferable surface-active agent is octylphenoxypolyethoxyethyl phosphate. If necessary, the surface-active agents can be used in combination of two or more compounds.

Preferably the concentration of the surface-active agent is in the range of 0.1 g/L to 10 g/L, more preferably in the range from 0.5 g/L to 5 g/L.

The present developing solution is preferably used for the development of the alkali-soluble photoresist containing an epoxy-containing substance.

Thus, the present invention is related to a method for forming a photoresist relief image, consisting of
1) coating an alkali-soluble photoresist composition containing an epoxy-containing substance on an aluminum base body, and
2) exposing and then developing the layer of the photoresist composition on the base body to obtain a photoresist relief image. The developing solution used is the developing solution of the present invention.

In the present invention, the aluminum base body is a base body containing aluminum (Al) as the metal component. It is not limited to pure metal aluminum, but also includes alloys with, for example, Mg, Mn, Fe, Si, Zn, Cu, Cr, etc. Moreover, the aluminum base body is an aluminum base body with a circuit formed on it. In particular, it is a base body containing aluminum and being formed on a wafer.

The photoresist used in the present invention contains an epoxy-containing substance. The epoxy-containing substance is any organic compound with at least one oxirane ring that can be polymerized by ring-opening. This substance is called epoxide in a wide sense. It includes monomer epoxy compounds, aliphatic, alicyclic, aromatic and heterocyclic oligomer and polymer epoxides. Such a preferable substance usually has at least two polymerizable epoxy groups per molecule. The polymer epoxide includes linear polymers with terminal epoxy groups (for example, diglycidyl ether of polyoxyalkylene glycol), polymers with skeletal oxirane units (for example, polybutadiene polyepoxide), and polymers with side-chain epoxy groups (for example, glycidyl methacrylate polymer or copolymer). The epoxide can be a pure compound, or, usually, a mixture containing one, two or more epoxy groups per molecule.

Useful epoxy-containing substances are various, from low molecular weight monomeric substances and oligomers to relatively high molecular weight polymers. The main chains and substituent groups are also highly varied. For example, the main chain can be of any type, while the substituent groups can be any, except those that react with the oxirane ring at room temperature. Specific examples of an appropriate substituent group include halogens, ester group, ether, sulfonate group, siloxane group, nitro group, and phosphate group.

Another useful epoxy-containing substance in the present invention is a glycidyl ether. Specific examples include multivalent phenol ethers [such as diglycidyl ether of 2,2-bis-(2,3-epoxy-propoxyphenol)propane] obtained by reaction between a multivalent alcohol and an excess of a chlorohydrin (such as epichlorohydrin). Other specific examples of this type of epoxide are described in U.S. Pat. No. 3,018,262. There are many commercially available epoxy-containing substances that can be used in the present invention. In particular, readily available epoxides include epichlorohydrin, glycidol, glycidyl methacrylate, diglycidyl ether of p-tert-butylphenol (for example, the product with a trade name of Epi-Rez 5014 from Celanese), diglycidyl ether of bisphenol A (such as the products with trade names of Epon 828, Epon 1004 and Epon 1010, respectively, made by the Shell Chemical Co., and Der-331, Der-332 and Der-334 made by the Dow Chemical Co.), vinyl cyclohexenedioxide (such as ERL-4206 made by Union Carbide Corp.), 3,4-epoxy-6-methyl-cyclohexylmethyl-3,4-epoxy-6-methylcyclohexene carboxylate (such as ERL-4201 made by Union Carbide Corp.), bis(3,4-epoxy-6-methylcyclohexylmethyl)adipate (such as ERL-4289 made by Union Carbide Corp.), bis(2,3-epoxycyclopentyl)ether (such as ERL-0400 made by Union Carbide Corp.), polypropylene glycol-modified aliphatic epoxy (such as ERL-4050 and ERL-4269 made by Union Carbide Corp.), dipentene dioxide (such as ERL-4269 made by Union Carbide Corp.), nonflammable epoxy resin (such as the brominated bisphenyl type epoxy resin DER-580 from Dow Chemical Co.), 1,4-butanediol diglycidyl ether of phenol formaldehyde novolac (such as DEN-431 and DEN-438 made by the Dow Chemical Co.), and resorcinol diglycidyl ether (such as Kopoxite made by the Koppers Company, Inc.).

The photoresist used in the present invention can contain a resin binder without an epoxy group.

The resin binder can be any substance that undergoes a photo-crosslinking reaction with at least one component of the composition. An appropriate resin includes one with a functional group having at least one reactive portion, such as reactive hydrogen. Phenol resin is a particularly appropriate reactive resin. It is preferably used at a concentration sufficient for developing the coated layer of the composition with an aqueous or semi-aqueous solution. An appropriate phenol resin includes the phenol-aldehyde condensed substance known as novolac resin in the industry, homopolymer and copolymer of alkenyl phenol, partially hydrogenated novolac and poly(vinyl phenol)resin, and homopolymer and copolymer of N-hydroxyphenyl-maleimide.

Among the phenol resins appropriate as the resin binder, phenol formaldehyde novolac is a preferable substance. The reason is that novolac can form a photoimage forming coating composition, which can be developed with an aqueous solution. These resins are produced by standard methods described in many publications, such as DeForest Photoresist Materials and Processes, McGraw-Hill Book Company, New York, Ch. 2, 1975; Moreau, Semiconductor Lithography Principles, Practices and Materials, Plenum Press, New York, Chs. 2 and 4, 1988; and Knop and Pilato, Phenolic Resins, Springer-Verlag, 1985.

Novolac resin is a thermosetting condensation product of phenol and aldehyde. Specific examples of phenols suitable for the condensation with an aldehyde, particularly formaldehyde, for production of novolac resin include phenol, m-cresol, o-cresol, p-cresol, 2,4-xylenol, 2,5-xylenol, 3,4-xylenol, 3,5-xylenol, thymol, and their mixtures. An appropriate novolac resin with a molecular weight of about 500-100,000 dalton is formed in an acid-catalyzed condensation reaction.

Another preferable phenol resin is poly(vinyl phenol). Poly(vinyl phenol)resin is a thermosetting material that can be formed by block polymerization, emulsion polymerization or solution polymerization of the corresponding monomer in the presence of a cationic catalyst. Vinyl phenol used in the production of poly(vinyl phenol) resin can be prepared by, for example, hydrolysis of commercially available coumarin or substituted coumarin followed by decarboxylation of the resultant hydroxycinnamic acid. It also can be prepared by decarboxylation of hydroxycinnamic acid obtained by dehydration of hydroxyalkylphenol or by reaction between substituted or unsubstituted hydroxybenzaldehyde and malonic acid. The preferable poly(vinyl phenol) resin prepared using such a vinyl phenol has a molecular weight of about 2,000- about 100,000 dalton. U.S. Pat. No. 4,439,516 also disclosed the method for producing poly(vinyl phenol) resin.

Another appropriate reactive resin is a polymer having a structure similar to that of novolac resin or poly(vinyl phenol) resin and containing phenol units and non-aromatic cyclic alcohol units. This type of copolymer is described in European Patent Application Publication No. 0401499 published on Dec. 12, 1990.

An additional appropriate phenol type-reactive resin is homopolymer or copolymer of N-hydroxyphenyl maleimide. This type of substance is described in European Patent Application Publication No. 0255989, from page 2, line 45 to page 5, line 51.

The photoresist used in the present invention preferably contains an amine base substance as a cross-linking agent, such as melamine monomer, oligomer or polymer, various resins, such as melamine formaldehyde, benzoguanamine-formaldehyde, urea-formaldehyde, glycolyl-formaldehyde resin, or their combination. Particularly suitable cross-linking agent includes the melamine produced by the American Cyanamid Company located in Wayne, N.J., such as Cymel (registered trade mark) 300, 301, 303, 350, 370, 380, 1116 and 1130, benzoguanamine, such as Cymel (registered trade mark) 1123 and 1125, the glycolyl resin Cymel 1 (registered trade mark) 1170, 1171 and 1172, and the urea-based resin Beetle (registered trade mark) 60, 65 and 80. Many other similar amine base compounds are commercially available from various manufacturers.

Among the above amine cross-linking agents, melamine resin is the preferred one. In particular, melamine formaldehyde resin is preferable, that is, the product from the reaction between melamine and formaldehyde. These resins are usually ethers, such as trialkylolmelamine and hexalkylolmelamine. The alkyl group can contain 1-8 or more carbon atoms, but methyl is the preferable one. Depending on reaction conditions and concentration of formaldehyde, more complex units can be formed by interaction of methyl ether.

The photoresist composition used in the present invention further contains a radiation-sensitive component. The radiation-sensitive component usually is an additive in the composition. However, in the composition, the radiation-sensitive component also can form a part of a different component of the composition, such as the resin binder containing a photoactive side chain, or a photoactive group as a unit of the polymer chain of the binder.

The radiation-sensitive component is selected from compounds that can form an acid upon activating radiation (that is, acid-forming substances), and compounds that can form a base upon activating radiation (that is, base-forming substances).

Any known radiation-sensitive component can be used.

Normally, a preferable photo-acid-forming substance is an onium salt, more preferably an onium salt with a weakly nucleophilic anion. The above anion is a metal or non-metal with 2-7 valences, such as Sb, Sn, Fe, Bi, Al, Ga, In, Ti, Zr, Sc, D, Cr, Hf, Cu and anions of halogen complex of B, P and As. Specific examples of an appropriate onium salt include diaryl diazonium salts, onium salts of groups Va, Vb, Ia, Ib and I of the Periodic Table of Elements, such as halonium salts (in particular, aromatic iodonium and iodoxonium salts), quaternary ammonium, phosphonium and alusonium [phonetic] salts, aromatic sulfonium salts and sulfoxonium salts, and selenonium salts.

Another appropriate acid-forming substance is an iodonium salt. This type of preferable salt is formed from, for example, as described in U.S. Pat. No. 4,683,317, an aryl iodosotosylate and an aryl ketone.

Among the acid-forming substances, at least several nonionic organic compounds are appropriate. Preferable nonionic organic acid-forming substances include halogenated nonionic compounds (e. g., 1,1-bis[p-chlorophenyl]-2,2,2-trichloroethane (DDT), 1,1-bis[p-methoxyphenyl]-2,2,2-trichloroethane (Methoxychlor (registered trade mark)), 1,2,5,6,9,10-hexabromocyclododecane, 1,10-dibromodecane, 1,1-bis[p-chlorophenyl]2,2-dichloroethane, 4,4′-dichloro-2-(trichloromethyl)benzhydrol, 1,1-bis(chlorophenyl)2-2,2-trichloroethanol (Kelthane (registered trade mark)), hexachlorodimethylsulfone, 2-chloro-6-(trichloromethyl)pyridine, 0,0-diethyl-0-(3,5,6-trichloro-2-pyridyl)phosphorothioate (Dursban (registered trade mark), 1,2,3,4,5,6-hexachlorocyclohexane, N-(1,1-bis[p-chlorophenyl]-2,2,2-trichloroethylacetoamide, tris[2,3-dibromopropyl]isocyanurate, 2,2-bis[p-chlorophenyl]-1,1-dichloroethylene, and their isoforms, analogues, and residual compounds. Among these substances, tris[2,3-dibromopropyl]isocyanurate is particularly preferable. The appropriate acid-forming substances are described in European Patent Application Publication No. 0232972. The above mentioned residual compounds are formed during the synthesis of the above halogenated organic compounds and thus can be present in a small amount in products containing such an organic compound in a large quantity. Thus, they are impurities or other modified substances closely related to the above halogenated organic compounds.

An appropriate base-forming compound forms a base by photodecomposition upon exposure to activated radiation (for example, photo-opening). A base-forming substance normally is a neutral compound forming a base (for example, an organic base, such as amine) upon photo-activation. Various base-forming substances are considered to be suitable for use in the present composition. Appropriate base-forming substances can be organic compounds, such as photo-reactive carbamates including benzyl carbamate and benzoin carbamate. Other appropriate base-forming substances include O-carbamoyl hydroxylamine, O-carbamoyl oxime, aromatic sulfonamide, α-lactone, and amide compounds, such as N-(2-aryl-ethynyl)amide and amide.

Particularly preferable organic base-forming substances include 2-hydroxy-2-phenylacetophenone-N-cyclohexylcarbamate, o-nitrobenzyl-N-cyclohexylcarbamate, N-cyclohexyl-2-naphthalenesulfonamide, 3,5-dimethoxybenzyl-N-cyclohexylcarbamate, N-cyclohexyl-p-toluenesulfonamide and dibenzoin isophorone dicarbamate.

Metal coordination complexes forming a base upon exposure to activating radiation, such as the cobalt (III) complex described in J. Coatings Tech., 62, no. 786, 63-67 (June, 1990) are also appropriate substances.

The photo-acid- or photo-base-forming substance is contained in the photoresist in an amount sufficient for developing the coating layer of the composition by exposure to activating radiation or, if necessary, after post-exposure bake. More specifically, the photo-acid- or photo-base-forming substance is normally used at about 1-15 wt % against the entirety of solid materials of the composition, more typically at a concentration of about 1-6 wt % against the entirety of solid materials of the composition. However, the concentration of the photo-reactive component can be changed depending on the particular substance used.

The compound containing at least one electrophilic multiple bond is at least a cross-linking agent suitable for the composition containing the photo-base-forming compound. Specific examples of the electrophilic multiple bond include maleimide, α,β-unsaturated ketone, ester, amide, nitrile and other α,β-unsaturated electrophilic groups.

Among the cross-linking agents containing an electrophilic multiple bond, substances containing at least one maleimide group are particularly preferable. In particular, bismaleimide is preferable. A particularly preferable compound is 1,1′-(methylene-di-1,4-phenylene)bismaleimide. The other appropriate maleimide can be easily synthesized by a known method, such as heat- or acid-condensation reaction of maleic anhydride with a compound with a structure corresponding to R(NH₂)₂ [in the structure, R is as described in formula (I)]. See I. Varma et al., Polymer News, vol. 12, 294-306 (1987) for reference to this reaction.

The electrophilic multiple-bond-containing resin or the resin containing epoxy and electrophilic multiple bond also can be used in the composition of the present invention as an appropriate cross-linking agent. Many appropriate resins are commercially available, such as the bismaleimide resin with a trade name of Kerimid made by Rhone-Poulenc, and the bismaleide resin with a trade name of Thermax MB-8000 made by Kennedy and Klim, Inc. Appropriate bismaleide resins are also described in the above mentioned paper by I. Varma et al. and in U.S. Pat. No. 4,987,264.

Other appropriate cross-linking agents include aromatic compounds with at least one allyl substituent group (that is, aromatic compounds with at least one of the positions on the ring substituted by an allyl carbon of an alkylene group). Appropriate allyl aromatic compounds include allylphenyl compounds. More preferable are allylphenol compounds. The allylphenol hardening agent can be a monomer, oligomer or polymer with at least one phenol unit and with at least one of the ring positions on the phenol unit(s) substituted by an allyl carbon of an alkylene group.

In general, an appropriate concentration of at least one cross-linking agent is about 5-30 wt % of the entire solid materials of the composition, preferably about 10-20 wt % of the entire solid materials.

In the photoresist composition used in the present invention, a photosensitizing agent is also used as a preferable additive. It is included in the composition in an amount sufficient to increase the wavelength sensitivity. Appropriate sensitizing agents include, for example, 2-ethyl-9,10-dimethoxyanthracene, 9,10-dichloroanthracene, 9,10-phenylanthracene, 1-chloroanthracene, 2-methylanthracene, 9-methylanthracene, 2-t-butylanthracene, anthracene, 1,2-benzanthracene, 1,2,3,4-dibenzanthracene, 1,2,5,6-dibenzanthracene, 1,2,7,8-dibenzanthracene, 9,10-dimethoxydimethylanthracene, etc. Preferable sensitizing agents are 2-ethyl-9,10-dimethoxyanthracene, N-methylpheno-thiazine and isopropylthioxantone.

The photoresist composition used in the present invention can contain any other additives, such as dyestuff, filler, moisturizing agent, flame retardant, etc. Appropriate fillers include, for example, TALC (a product made by Cyprus Chemical), while an appropriate dyestuff includes Orasol Blue made by Ciba-Geigy.

The filler and dyestuff can be used at a high concentration, for example, at 5-30 wt % of the entirety of solid materials of the composition. Any other additives, such as moisturizing agent, foaming agent, dye dispersing agent, etc., are usually contained at a low concentration, for example, at a concentration less than about 3 wt % of the entirety of solid materials of the composition.

To produce the liquid coating composition, the components of the compositions are dissolved in an appropriate solvent, such as at least one glycol ether chosen from ethylene glycol monomethyl ether, propylene glycol monomethyl ether, and dipropylene glycol monomethyl ether, esters (e.g., methylcellosolve acetate, ethylcellosolve acetate, propylene glycol monomethyl ether acetate, and dipropylene glycol monomethyl ether acetate), other solvents (e. g., dibasic ester, propylene carbonate, γ-butyrolactone, etc.), and alcohols (e. g., n-propanol).

To produce the liquid coating composition, the dry components are dissolved in the solvent. The concentrations of the solids are dependent on several factors including the method for application onto the base body. In general, the concentration of the solids in the solvent can be about 10-70 wt % or higher of the total weight of the coating composition. More specifically, for a flow coating composition, the solid concentration can be at least 40-50 wt % of the total weight of the composition.

The photoresist composition can be coated onto the base body by a general method, such as screen printing, flow coating, roller coating, slot coating, spin coating, electrostatic blowing, blowing coating, or soaking coating, or as a dry film. As described above, the viscosity of the photoresist can be adjusted in accordance with the particular method used, for example, by adding more solvent for a method requiring a low viscosity, or adding a thickening agent and a filler for a method requiring a high viscosity.

After coating, the layer of the liquid composition is dried to remove the solvent, and, if necessary, it is heated to induce cross-linking.

Thus, the present invention provides a method to form the photoresist relief image, consisting of
1) coating an alkali-soluble photoresist composition containing an epoxy-containing substance on an aluminum base body, and
2) exposing and then developing the layer of the photoresist composition on the base body to obtain a photoresist relief image. The developing solution is the developing solution in the present invention.

The photoresist used in the present invention can be of negative or positive type. After exposure and, if necessary, cross-linking, the non-exposed portions (for negative type) or exposed portions (for positive type) are removed by the developing solution, thereby forming a relief image.

With the developing method of the present invention, the relief image formed by the epoxy-containing substance-containing, alkali-soluble photoresist composition can be obtained without erosion of the base body or the aluminum in the contact area with the developing solution.

Using the resultant relief image, a circuit can be formed by various treatments by standard methods.

### BEST EMBODIMENTS OF THE INVENTION

In the following, the present invention is further described in detail by way of practical examples. The practical examples are described as examples, but are not intended to limit the scope of the present invention.

### PRACTICAL EXAMPLES

In these practical examples, the following chelating agents were used. In the practical examples, the types of chelating agents are shown by the respective symbols. Chelating agents A-G represent practical examples of the present invention, whereas agents H-S represent comparative examples.
A: 1-hydroxyethylidene-1,1-diphosphonate
B: aminotrimethylene phosphonate
C: 2-phosphonobutane-1,2,4-tricarboxylate
D: ethylenediamine tetramethylene phosphonate
E: diethylenetriamine pentamethylene phosphonate
F: hexamethylenediamine tetramethylene phosphonate
G: diethylenetriamine penta(methylene phosphonate)
H: nitrilotriacetate
I: diethylenetriamine pentaacetate
J: ethylenediamine tetraacetate
K: triethylenetetramine hexaacetate
L: glycine
M: glycolic acid
N: sodium tripolyphosphorate
O: malonic acid
P: hexamethylenediamine tetraacetate
Q: triethylenetetramine hexaacetate
R: 1,3-diamino-2-hydroxypropane tetraacetate
S: 1,3-propanediamine tetraacetate

### Practical Example 1

A liquid with the composition shown in Table 1 was prepared, and the state of precipitate and erosion of aluminum were evaluated. The surface-active agent used was octylphenoxypolyethoxyethyl phosphate (Triton QS-44 (Union Carbide).

Each test liquid was adjusted to pH=13.5 for use.

Method for Measuring Aluminum Erosion:

An aluminum sample with a size of 2×2 cm² spot-coated on a silicone base body was soaked in 50 mL of each test liquid at 35° C. for 5 min. The amount of aluminum dissolved in the liquid was measured by ICP (induction combination [literal] high-frequency plasma spectrometry).

Method for Measuring Liquid Stability:

The test liquid was stored at 45° C. for a specified period of time, and the presence of precipitate was evaluated visually.

TABLE 1

| | Practical example No. | | | | | |
|---|---|---|---|---|---|---|
| | 1 | 2 | 3 | 4 | 5 | 6 |
| Alkali builder | NaOH | NaOH | NaOH | NaOH | NaOH | NaOH |
| concentration | 0.42 N | 0.42 N | 0.42 N | 0.42 N | 0.42 N | 0.42 N |
| Chelating agent | no | no | no | H | I | J |
| | | | | 0.005 M | 0.005 M | 0.005 M |
| CaCl₂.2H₂O | no | 0.005 M | 0.005 M | 0.005 M | 0.005 M | 0.005 M |
| Triton QS-44 | no | no | 3 g/L | 3 g/L | 3 g/L | 3 g/L |
| Precipitate | no | yes | yes | yes | no | no |
| Al erosion | very | very | very | fast | fast | fast |
| | slow | slow | slow | | | |
| | Practical example No. | | | | | |
| | 7 | 8 | 9 | 10 | 11 | 12 |
| Alkali builder | NaOH | NaOH | NaOH | NaOH | NaOH | NaOH |
| concentration | 0.42 N | 0.42 N | 0.42 N | 0.42 N | 0.42 N | 0.42 N |
| Chelating agent | K | L | M | N | O | A |
| | 0.005 M | 0.005 M | 0.005 M | 0.005 M | 0.005 M | 0.005 M |
| CaCl₂.2H₂O | 0.005 M | 0.005 M | 0.005 M | 0.005 M | 0.005 M | 0.005 M |
| Triton QS-44 | 3 g/L | 3 g/L | 3 g/L | 3 g/L | 3 g/L | 3 g/L |
| Precipitate | no | yes | a little | a little | yes | no |
| Al erosion | fast | very | very | very | very | very |
| | | slow | slow | slow | slow | slow |

It can be seen from the experimental data, that Ca precipitation and aluminum erosion were dependent on types of chelating agents, and that 1-hydroxyethylidene-1,1-diphosphonate gives rise to good results.

In Practical Example 12, when chelating agents B-G were used instead of chelating agent A, the same good results as with chelating agent A were obtained.

### Practical Example 2

A test liquid with the composition shown in Table 2 was prepared using chelating agent A, and the state of precipitate and erosion of aluminum were evaluated.

TABLE 2

| | Practical example No. | | | | |
|---|---|---|---|---|---|
| | 13 | 14 | 15 | 16 | 17 |
| Alkali | NaOH | NaOH | NaOH | NaOH | NaOH |
| builder | 0.42 N | 0.42 N | 0.42 N | 0.42 N | 0.42 N |
| concen- | | | | | |
| tration | | | | | |
| Citric acid | no | 0.005 M | no | no | no |
| Chelating | no | no | 0.005 M | no | no |
| agent M | | | | | |
| Chelating | no | no | no | 0.005 M | no |
| agent N | | | | | |
| Chelatingno | no | no | no | 0.005 M | |
| agent G | | | | | |
| Chelating | 0.005 M | 0.005 M | 0.005 M | 0.005 M | 0.005 M |
| agent A | | | | | |
| CaCl₂.2H₂O | 0.005 M | 0.005 M | 0.005 M | 0.005 M | 0.005 M |
| Triton QS-44 | 3 g/L | 3 g/L | 3 g/L | 3 g/L | 3 g/L |
| Precipitate | yes | a little | a little | a little | a little |
| (45° C., | | | | | |
| 24 hr) | | | | | |
| Al erosion | very slow | very slow | very slow | very slow | very slow |

TABLE 3

| | Practical example No. | | | | | | | |
|---|---|---|---|---|---|---|---|---|
| | 18 | 19 | 20 | 21 | 22 | 23 | 24 | 25 |
| Alkali builder | KOH | KOH | KOH | KOH | KOH | KOH | KOH | KOH |
| concentration | 0.42 N | 0.42 N | 0.42 N | 0.42 N | 0.42 N | 0.42 N | 0.42 N | 0.42 N |
| Citric acid | 0.005 M | no | no | no | 0.005 M | 0.005 M | 0.005 M | 0.005 M |
| Chelating | no | 0.005 M | no | no | no | no | no | no |
| agent M | | | | | | | | |
| Chelating | no | no | 0.005 M | no | no | no | no | no |
| agent N | | | | | | | | |
| Chelating | no | no | no | 0.005 M | no | no | no | 0.005 M |
| agent E | | | | | | | | |
| Chelating | 0.005 M | 0.005 M | 0.005 M | 0.005 M | no | no | no | no |
| agent A | | | | | | | | |
| Chelating | no | no | no | no | 0.005 M | no | no | no |
| agent B | | | | | | | | |
| Chelating | no | no | no | no | no | 0.005 M | no | no |
| agent C | | | | | | | | |
| Chelating | no | no | no | no | no | no | 0.005 M | no |
| agent D | | | | | | | | |
| CaCl₂.2H₂O | 0.005 M | 0.005 M | 0.005 M | 0.005 M | 0.005 M | 0.005 M | 0.005 M | 0.005 M |
| Triton QS-44 | 3 g/L | 3 g/L | 3 g/L | 3 g/L | 3 g/L | 3 g/L | 3 g/L | 3 g/L |
| Precipitate | no | no | no | no | no | no | no | no |
| (45° C., 168 hr) | | | | | | | | |
| Al erosion | very slow | very slow | very slow | very slow | very slow | very slow | very slow | very slow |

It can be seen from the experimental data, that the storage stability was significantly increased by adding a chelating assistant.

### Practical Example 3

The effects of various ratios of chelating agent to calcium ion were investigated for various chelating agents by the above method for measuring aluminum erosion.

| | Ca:chelating agent, | |
|---|---|---|
| Chelating agent | molar ratio | Result |
| A | 1:0.5 | At about 3 min a small amount of |
| | | reaction gas was generated. |
| | 1:1 | At about 4-5 min a small amount |
| | | of reaction gas was generated |
| | 1:1.5 | At about 4-5 min a small amount |
| | | of reaction gas was generated. |
| B | 1:0.5 | At about 2 min a small amount of |
| | | reaction gas was generated. |
| | 1:1 | At about 2 min a small amount of |
| | | reaction gas was generated. |
| | 1:1.5 | At about 30 sec reaction gas was |
| | | generated vigorously. |
| C | 1:0.5 | Turbid, and at about 3 min a |
| | | small amount of reaction gas was |
| | | generated (not clear due to the |
| | | turbidity). |
| | 1:1 | At about 1.5 min a small amount |
| | | of reaction gas was generated. |
| | 1:1.5 | At about 1.5 min a small amount |
| | | of reaction gas was generated. |
| D | 1:0.5 | At about 3 min a small amount of |
| | | reaction gas was generated. |
| | 1:1 | At about 10 sec reaction gas was |
| | | generated vigorously. |
| | 1:1.5 | At about 10 sec reaction gas was |
| | | generated vigorously. |
| E | 1:0.5 | At about 2 min a small amount of |
| | | reaction gas was generated. |
| | 1:1 | At about 35 sec reaction gas was |
| | | generated vigorously. |
| | 1:1.5 | At about 35 sec reaction gas was |
| | | generated vigorously. |
| F | 1:05 | At about 2 min a small amount of |
| | | reaction gas was generated. |
| | 1:1 | At about 2 min a small amount of |
| | | reaction gas was generated. |
| | 1:1.5 | At about 30 sec reaction gas was |
| | | generated vigorously. |
| G | 1:0.5 | At about 2 min a small amount of |
| | | reaction gas was generated. |
| | 1:1 | At about 2 min a small amount of |
| | | reaction gas was generated. |
| | 1:1.5 | At about 30 sec reaction gas was |
| | | generated vigorously. |

It can be seen from the experimental data that, for chelating agents A-G, when the Ca: chelating agent molar ratio was 1:0.5, the results were good in all cases. Depending on the particular types of chelating agents, the preferable Ca: chelating agent molar ratio varied. However, it can be seen that, for chelating agents A and C, good results were obtained in a large range from 1:0.5 to 1:1.5.

Chelating agents H, Q, R and S were also used to perform the above experiment. The results were not good for any of the chelating agents, at any ratio, with colloid formation or turbidity or vigorous reaction gas generation within about 20-30 sec.

### Practical Example 4

Development Test

A photoresist containing a novolac resin at about 25 wt %, a bisphenol A type epoxy resin at about 30 wt %, a solvent at about 40 wt % and other components, such as initiator at about 5 wt % was used to perform the experiment.

The composition was coated to a thickness of about 10 micron using a spin coater. After baking at 90° C. for 30 min in a convection oven, exposure at 1000 mJ was performed using USHIO UV1000SA (USHIO Denki Corp., Ltd.). After baking at 70° C. for 20 min, development was performed at 35° C. for 2-3 min, followed by rinsing with deionized water for 3 min.

The formed 50-20 micron pier [phonetic] shape was examined in a metallographic microscope or scanning electron microscope to evaluate the performance of the developing solution.

TABLE 4

| | Practical example No. | | | |
|---|---|---|---|---|
| | 26 | 27 | 28 | 29 |
| Alkali builder | NaOH | NaOH | KOH | KOH |
| concentration | 0.60 N | 0.42 N | 0.60 N | 0.42 N |
| Citric acid | 0.005 M | 0.005 M | 0.005 M | 0.005 M |
| CaCl₂.2H₂O | 0.005 M | 0.005 M | 0.005 M | 0.005 M |
| Chelating agent A | 0.005 M | 0.005 M | 0.005 M | 0.005 M |
| Triton QS-44 | no | 3 g/L | no | 3 g/L |
| Precipitate (45° C., | a little | a little | no | no |
| 168 hr) | | | | |
| Al erosion | very slow | very slow | very slow | very slow |
| Pier [phonetic] | Δ | ◯ | Δ | ◯ |
| profile | | | | |

From the experimental data, it is shown that the developing solution of the present invention can form good pier [phonetic] without precipitation or aluminum erosion. It is also shown that by using a surface-active agent good results can be obtained, and that when potassium hydroxide is used as the alkali builder, best results can be obtained.

Potential Utility in Industry

As described above, the developing solution of the present invention is used preferably as a developing solution for photoresist formed on an aluminum-containing base body formed on a wafer. More specifically, it is used preferably for the development of photoresist for the production of wafer level chip size package (WL-CSP), particularly WL-CSP with pier [phonetic] hole or trench.

1-8. (canceled)

9. A developer comprising an alkali builder, a calcium containing compound and a chelating agent, the chelating agent is selected from the group consisting of 1-hydroxyethylidene-1,1-diphosphonic acid, aminotrimethylenephosphonic acid, 2-phosphonobutane-1,2,4-tricarboxylic acid, ethylenediaminetetramethylenephosphonic acid, diethylenetriaminepentamethylenephosphonic acid, hexamethylenediaminetetramethylenephosphonic acid, diethylenetriaminepentamethylenephosphonic acid, and mixtures thereof.

10. The developer of claim 9, further comprising a chelating assistant.

11. The developer of claim 9, wherein the chelating assistant is selected from the group consisting of citric acid, glycolic acid, sodium tripolyphosphate, and mixtures thereof.

12. The developer of claim 9, wherein the calcium containing compound is selected from the group consisting of calcium chloride, calcium bromide, calcium iodide, calcium carbonate, calcium hydroxide, calcium nitrate, calcium acetate, and mixtures thereof.

13. A method for forming a relief image comprising: 1) coating an alkali-soluble photoresist composition comprising an epoxy-containing compound on an aluminum base; 2) exposing the photoresist composition to activating radiation; and 3) developing the photoresist composition on the aluminum base body to obtain a relief image, the developer comprises an alkali builder, a calcium containing compound and a chelating agent, the chelating agent is selected from the group consisting of 1-hydroxyethylene-1,1-diphosphonic acid, aminotrimethylenephosphonic acid, 2-phosphonobutane-1,2,4-tricarboxylic acid, ethylenediaminetetramethylenephosphonic acid, diethylenetriaminepentamethylenephosphonic acid, hexamethylenediaminetetramethylenephosphonic acid, and diethylenetriaminepentamethylenephosphonic acid.

14. The method of claim 13, wherein the developer further comprises a chelating assistant.

15. The method of claim 13, wherein the alkali-soluble photoresist composition further comprises a phenolic resin.

16. A method for forming a relief image comprising: 1) coating an alkali-soluble photoresist composition comprising an epoxy-containing compound on an aluminum base; 2) exposing the photoresist composition to activating radiation; 3) hardening the exposed portions of the photoresist composition; and 4) developing the photoresist composition on the aluminum base to obtain the relief image, the developer comprises an alkali builder, a calcium containing compound and a chelating agent, the chelating agent is selected from the group consisting of 1-hydroxyethylidene-1,1-diphosphonic acid, aminotrimethylenephosphonic acid, 2-phosphonobutane-1,2,4-tricarboxylic acid, ethylenediaminetetramethylenephosphonic acid, diethylenetriaminepentamethylenephosphonic acid, hexamethylenediaminetetramethylenephosphonic acid, and diethylenetriaminepentamethylenephosphonic acid.

17. The method of claim 16, wherein the developer further comprises a chelating assistant.

18. The method of claim 16, wherein the photoresist composition further comprises a phenolic resin.
